(19) United States
(12) Patent Application Publication
(10) Pub. No.: US 2012/0054657 A1
(43) Pub. Date: Mar. 1, 2012

(54) METHODS, APPARATUSES AND COMPUTER PROGRAM PRODUCTS FOR ENABLING EFFICENT COPYING AND PASTING OF DATA VIA A USER INTERFACE

(75) Inventor: Mikko Antero Nurmi, Tampere (FI)

(73) Assignee: Nokia Corporation

(21) Appl. No.: 12/872,885

(22) Filed: Aug. 31, 2010

(51) Int. Cl. G06F 3/048

(52) U.S. Cl. 715/769

(57) ABSTRACT

An apparatus for providing a user-friendly and reliable manner for copying and pasting data may include a processor and memory storing executable computer program code that cause the apparatus to at least perform operations including copying a selected item(s) of data responsive to an indication that a portion of the selected item(s) of data is moved outside of a viewable area at an edge of a display. The computer program code may further cause the apparatus to generate visible indicia denoting the selected item(s) of data is copied and display a portion of the visible indicia at the respective edge. The computer program code may further cause the apparatus to paste the copied item(s) of data within the display responsive to an indication that a selection of visible indicia is moved from the edge to the respective area and is released. Corresponding methods and computer program products are also provided.

### TECHNOLOGICAL FIELD

An example embodiment of the invention relates generally to user interface technology and, more particularly, relates to a method, apparatus, and computer program product for providing a user-friendly and efficient manner in which to enable copying and pasting of data via a user interface.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase convenience to users relates to improving a user's ability to effectively interface with the user's communication device. Accordingly, numerous user interface mechanisms have been developed to attempt to enable a user to more easily accomplish tasks or otherwise improve the user's experience in using the device. In this regard for example, a user's experience during certain applications such as, for example, web browsing or applications that enable copying and pasting of data may be enhanced by using a touch screen display as the user interface.

For instance, user interfaces such as touch screen devices currently offer copy and paste features for transferring text, data, files, objects or the like from a source to a destination. Typically, current communication devices utilize methods such as key-combinations (e.g., depressing a command key (e.g., Ctrl key) while typing letters (e.g., “C” for copy and “V” for paste), pulldown menus, pop-up menus, toolbar buttons or other mechanisms for selecting data to enable copying and pasting of the data that is accessible via a user interface of the device.

In current communication devices when data is selected for copying, the copied data may be moved to an area of memory referred to as a clipboard without removing the data from its current location. The copied data in the clipboard typically remains invisible. Since the copied data in the clipboard typically remains invisible, the user may inadvertently forget that data has been selected for copying. In this regard, if a user performs another operation (e.g., a copy operation, a cut operation that deletes data) before pasting the copied data, the previously copied data may be overwritten or removed from memory. Thus, when the user selects a location on a user interface to visibly insert copied data, the user may be unable to paste the copied data and may need to perform the copy-paste operation again. As a result, existing mechanisms of copying and pasting data may be cumbersome and inefficient to users of communication devices and may result in user dissatisfaction.

In view of the foregoing drawbacks, it may be desirable to provide an alternative mechanism in which to enable copying and pasting of data via a user interface.

### SUMMARY

A method, apparatus and computer program product are therefore provided for providing a user-friendly, efficient and reliable manner in which to enable copying and pasting of data via a user interface of a communication device.

An example embodiment may provide an efficient and intuitive copy-paste functionality for a communication device. In this regard, an example embodiment may enable a user of a communication device to select an item(s) of data visible on a display by tapping the item(s) of data with a pointer or the like (e.g., a finger, stylus, pen, pencil, mouse, touch pad, etc.). An example embodiment may facilitate copying of the selected item(s) of data in response to the user moving the selected item(s) of data to an edge of a display such that at least a portion of the selected item(s) of data is outside of a viewable area of the display. In one embodiment, the display may include an even surface. In an alternative embodiment, the display may not have an even surface and instead may continue around edges of the display. In one example embodiment, visible indicia (e.g., a graphical element (e.g., an icon, thumbnail, etc.)) may be generated denoting that a selected item(s) of data is copied. The example embodiment may enable display of the visible indicia at an edge(s) of the display where the selected item(s) of data was moved. The visible indicia may serve as an indicator to the user that the selected item(s) of data is copied for pasting into an area within the display. An example embodiment may enable provision of multiple copies of selected items of data to be available for pasting at a given time. In this regard, an example embodiment may enable display of multiple items of visible indicia at respective edges of the display corresponding to respective items of the copied data.

It should be pointed out that the displayed visible indicia may remain on a screen of the display even when a view of the display is changed. For purposes of illustration and not of limitation, if the display is showing an email message along with the visible indicia and a view of the display is changed to a web page, the visible indicia may remain visible at a respective area (e.g., an edge(s)) of the display when the web page is being shown. An example embodiment may facilitate pasting of the copied content in response to receipt of an indication that a user moved visible indicia inside the viewable area of the display and de-selects or releases a selection of the visible indicia at a respective area within the display.

In one example embodiment, a method for providing a user-friendly and reliable manner for copying and pasting data is provided. The method may include generating a copy, via a processor, of at least one selected item of data. The copy of the selected item of data may be generated in response to receipt of an indication that at least a portion of the selected item of data is moved outside of a viewable area of a display or a window of the display at a respective edge of the display or window. The method may further include generating visible indicia denoting that the selected item of data is copied and enabling display of a portion of the visible indicia at the respective edge. The method may further include causing pasting of the copied item of data at a respective area within the display in response to receipt of an indication that a selection of the visible indicia is moved from the respective edge to the respective area and that the selection is released at the respective area.

In another example embodiment, an apparatus for providing a user-friendly and reliable manner for copying and pasting data is provided. The apparatus may include a processor and a memory including computer program code. The memory and the computer program code are configured to, with the processor, cause the apparatus to at least perform operations including generating a copy of at least one selected item of data. The copy of the selected item of data may be generated in response to receipt of an indication that at least a portion of the selected item of data is moved outside of a viewable area of a display or a window of the display at a respective edge of the display or window. The memory and the computer program code may further cause the apparatus to generate visible indicia denoting that the selected item of data is copied and may enable display of a portion of the visible indicia at the respective edge. The memory and the computer program code may further cause the apparatus to cause pasting of the copied item of data at a respective area within the display in response to receipt of an indication that a selection of the visible indicia is moved from the respective edge to the respective area and that the selection is released at the respective area.

In another example embodiment, a computer program product for providing a user-friendly and reliable manner for copying and pasting data is provided. The computer program product includes at least one computer-readable storage medium having computer-executable program code instructions stored therein. The computer executable program code instructions may include program code instructions configured to generate a copy of at least one selected item of data. The copy of the selected item of data may be generated in response to receipt of an indication that at least a portion of the selected item of data is moved outside of a viewable area of a display or a window of the display at a respective edge of the display or window. The program code instructions may also generate visible indicia denoting that the selected item of data is copied and enable display of a portion of the visible indicia at the respective edge. The program code instructions may also cause pasting of the copied item of data at a respective area within the display in response to receipt of an indication that a selection of the visible indicia is moved from the respective edge to the respective area and that the selection is released at the respective area.

In another example embodiment, an apparatus for providing a user-friendly and reliable manner for copying and pasting data is provided. The apparatus may include means for generating a copy of at least one selected item of data. The copy of the selected item of data may be generated in response to receipt of an indication that at least a portion of the selected item of data is moved outside of a viewable area of a display or a window of the display at a respective edge of the display or window. The apparatus may also include means for generating visible indicia denoting that the selected item of data is copied and means for enabling display of a portion of the visible indicia at the respective edge. The apparatus may also include means for causing pasting of the copied item of data at a respective area within the display in response to receipt of an indication that a selection of the visible indicia is moved from the respective edge to the respective area and that the selection is released at the respective area.

An embodiment of the invention may provide a better user experience given the ease and efficiency in performing copy-paste functions via a user interface. As a result, device users may enjoy improved capabilities with respect to applications and services accessible via the device.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus for providing a user-friendly, efficient and reliable manner in which to enable copying and pasting of data according to an example embodiment of the invention;

FIGS. 3A, 3B and 3C are diagrams illustrating copying of image data according to an example embodiment of the invention;

FIGS. 4A, 4B and 4C are diagrams illustrating pasting of image data according to an example embodiment of the invention;

FIGS. 5A and 5B are diagrams illustrating copying and pasting of text data according to an example embodiment of the invention; and

FIG. 6 illustrates a flowchart for providing a user-friendly, efficient and reliable manner in which to enable copying and pasting of data according to an example embodiment of the invention.

### DETAILED DESCRIPTION

Some embodiments of the invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,”“content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein a thumbnail(s) may be a graphical element including but not limited to an icon or like that may relate to a compressed or reduced version of a copied item(s) of data or at least a portion of a copied item(s) of data depicting information that may be representative of uncompressed data. In this regard, a thumbnail may represent regular (e.g., uncompressed) content.

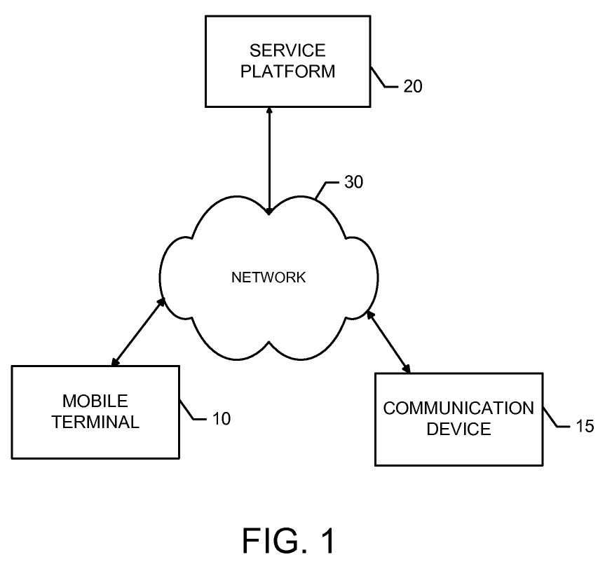

FIG. 1 illustrates a block diagram of a system that may benefit from an embodiment of the invention. It should be understood, however, that the system as illustrated and hereinafter described is merely illustrative of one system that may benefit from an example embodiment of the invention and, therefore, should not be taken to limit the scope of embodiments of the invention. As shown in FIG. 1, an embodiment of a system in accordance with an example embodiment of the invention may include a mobile terminal 10 capable of communication with numerous other devices including, for example, a service platform 20 via a network 30. In one embodiment of the invention, the system may further include one or more additional communication devices (e.g., communication device 15) such as other mobile terminals, personal computers (PCs), servers, network hard disks, file storage servers, and/or the like, that are capable of communication with the mobile terminal 10 and accessible by the service platform 20. However, not all systems that employ an embodiment of the invention may comprise all the devices illustrated and/or described herein. Moreover, in some cases, an embodiment may be practiced on a standalone device independent of any system.

The mobile terminal 10 may be any of multiple types of mobile communication and/or computing devices such as, for example, portable digital assistants (PDAs), pagers, mobile televisions, mobile telephones, gaming devices, wearable devices, head mounted devices, laptop computers, touch surface devices, cameras, camera phones, video recorders, audio/video players, radios, global positioning system (GPS) devices, or any combination of the aforementioned, and other types of voice and text communications systems. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30.

Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), LTE advanced (LTE-A) and/or the like. Thus, the network 30 may be a cellular network, a mobile network and/or a data network, such as a Local Area Network (LAN), a Metropolitan Area Network (MAN), and/or a Wide Area Network (WAN), e.g., the Internet. In turn, other devices such as processing elements (e.g., personal computers, server computers or the like) may be included in or coupled to the network 30. By directly or indirectly connecting the mobile terminal 10 and the other devices (e.g., service platform 20, or other mobile terminals or devices such as the communication device 15) to the network 30, the mobile terminal 10 and/or the other devices may be enabled to communicate with each other, for example, according to numerous communication protocols, to thereby carry out various communication or other functions of the mobile terminal 10 and the other devices, respectively. As such, the mobile terminal 10 and the other devices may be enabled to communicate with the network 30 and/or each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as Wireless LAN (WLAN), Worldwide Interoperability for Microwave Access (WiMAX), WiFi, Ultra-Wide Band (UWB), Wibree techniques and/or the like and fixed access mechanisms such as Digital Subscriber Line (DSL), cable modems, Ethernet and/or the like.

In an example embodiment, the service platform 20 may be a device or node such as a server or other processing element. The service platform 20 may have any number of functions or associations with various services. As such, for example, the service platform 20 may be a platform such as a dedicated server (or server bank) associated with a particular information source or service (e.g., a service associated with sharing user interface settings), or the service platform 20 may be a backend server associated with one or more other functions or services. As such, the service platform 20 represents a potential host for a plurality of different services or information sources. In one embodiment, the functionality of the service platform 20 is provided by hardware and/or software components configured to operate in accordance with known techniques for the provision of information to users of communication devices. However, at least some of the functionality provided by the service platform 20 may be data processing and/or service provision functionality provided in accordance with an example embodiment of the invention.

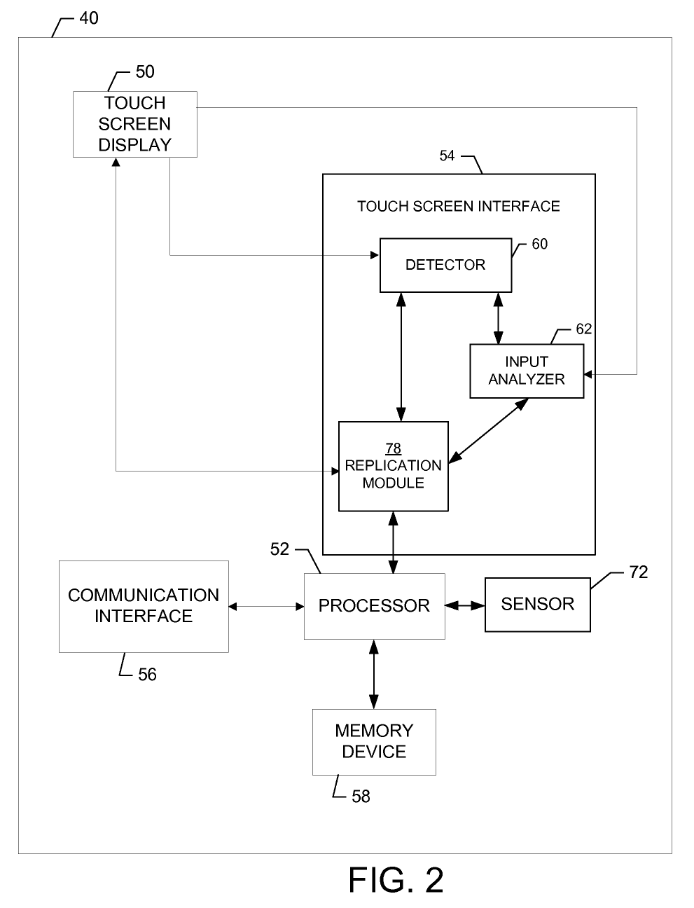

In an example embodiment, the mobile terminal 10 may employ an apparatus (e.g., the apparatus of FIG. 2) capable of employing an embodiment of the invention. Moreover, the communication device 15 may also implement an embodiment of the invention.

FIG. 2 illustrates a schematic block diagram of an apparatus for employing a user-friendly input interface in communication with a touch screen display that enables efficient and reliable copying and pasting of data according to an example embodiment of the invention. An example embodiment of the invention will now be described with reference to FIG. 2, in which certain elements of an apparatus 40 are displayed. The apparatus 40 of FIG. 2 may be employed, for example, on the mobile terminal 10 (and/or the communication device 15). Alternatively, the apparatus 40 may be embodied on a network device of the network 30. However, the apparatus 40 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 40 may include or otherwise be in communication with a touch screen display 50, a processor 52, a touch screen interface 54, a communication interface 56, a memory device 58, a sensor 72, an input analyzer 62, a detector 60 and a replication module 78. The memory device 58 may include, for example, volatile and/or non-volatile memory. For example, the memory device 58 may be an electronic storage device (e.g., a computer readable storage medium) comprising gates configured to store data (e.g., bits) that may be retrievable by a machine (e.g., a computing device like processor 52). In an example embodiment, the memory device 58 may be a tangible memory device that is not transitory. The memory device 58 may be configured to store information, data, files, applications, instructions or the like for enabling the apparatus to carry out various functions in accordance with an example embodiment of the invention. For example, the memory device 58 could be configured to buffer input data for processing by the processor 52. Additionally or alternatively, the memory device 58 could be configured to store instructions for execution by the processor 52. As yet another alternative, the memory device 58 may be one of a plurality of databases that store information and/or media content (e.g., pictures, videos, etc.).

The apparatus 40 may, in one embodiment, be a mobile terminal (e.g., mobile terminal 10) or a fixed communication device or computing device configured to employ an example embodiment of the invention. However, in one embodiment, the apparatus 40 may be embodied as a chip or chip set. In other words, the apparatus 40 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 40 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 52 may be embodied in a number of different ways. For example, the processor 52 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 52 may be configured to execute instructions stored in the memory device 58 or otherwise accessible to the processor 52. As such, whether configured by hardware or software methods, or by a combination thereof, the processor 52 may represent an entity (e.g., physically embodied in circuitry) capable of performing operations according to an embodiment of the invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the algorithms and operations described herein when the instructions are executed. However, in some cases, the processor 52 may be a processor of a specific device (e.g., a mobile terminal or network device) adapted for employing an embodiment of the invention by further configuration of the processor 52 by instructions for performing the algorithms and operations described herein. The processor 52 may include, among other things, a clock, an arithmetic logic unit (ALU) and logic gates configured to support operation of the processor 52.

In an example embodiment, the processor 52 may be configured to operate a connectivity program, such as a browser, Web browser or the like. In this regard, the connectivity program may enable the apparatus 40 to transmit and receive Web content, such as for example location-based content or any other suitable content, according to a Wireless Application Protocol (WAP), for example. It should be pointed out that the processor 52 may also be in communication with the touch screen display 50 and may instruct the display to illustrate any suitable information, data, content (e.g., media content) or the like.

Meanwhile, the communication interface 56 may be any means such as a device or circuitry embodied in either hardware, a computer program product, or a combination of hardware and software that is configured to receive and/or transmit data from/to a network and/or any other device or module in communication with the apparatus 40. In this regard, the communication interface 56 may include, for example, an antenna (or multiple antennas) and supporting hardware and/or software for enabling communications with a wireless communication network (e.g., network 30). In fixed environments, the communication interface 56 may alternatively or also support wired communication. As such, the communication interface 56 may include a communication modem and/or other hardware/software for supporting communication via cable, Digital Subscriber Line (DSL), Universal Serial Bus (USB), Ethernet, High-Definition Multimedia Interface (HDMI) or other mechanisms. Furthermore, the communication interface 56 may include hardware and/or software for supporting communication mechanisms such as Bluetooth, Infrared, Ultra-Wideband (UWB), WiFi and/or the like.

The touch screen display 50 may be configured to enable touch recognition by any suitable technique, such as resistive, capacitive, infrared, strain gauge, surface wave, optical imaging, dispersive signal technology, acoustic pulse recognition, or other like techniques. The touch screen display 50 may also detect finger movements just above the touch screen display even in an instance in which the finger may not actually touch the touch screen of the display 50. The touch screen interface 54 may be in communication with the touch screen display 50 to receive indications of user inputs at the touch screen display 50 and to modify a response to such indications based on corresponding user actions that may be inferred or otherwise determined responsive to the indications. In this regard, the touch screen interface 54 may be any device or means embodied in either hardware, software, or a combination of hardware and software configured to perform the respective functions associated with the touch screen interface 54 as described below. In an example embodiment, the touch screen interface 54 may be embodied in software as instructions that are stored in the memory device 58 and executed by the processor 52. Alternatively, the touch screen interface 54 may be embodied as the processor 52 configured to perform the functions of the touch screen interface 54.

The touch screen interface 54 may be configured to receive an indication of an input in the form of a touch event at the touch screen display 50. Following recognition of the touch event, the touch screen interface 54 may be configured to thereafter determine a stroke event or other input gesture and provide a corresponding indication on the touch screen display 50 based on the stroke event. In this regard, for example, the touch screen interface 54 may include a detector 60 to receive indications of user inputs in order to recognize and/or determine a touch event based on each input received at the detector 60.

In an example embodiment, one or more sensors (e.g., sensor 72) may be in communication with the detector 60. The sensors may be any of various devices or modules configured to sense one or more conditions. In this regard, for example, a condition(s) that may be monitored by the sensor 72 may include pressure (e.g., an amount of pressure exerted by a touch event) and any other suitable parameters (e.g., an amount of time in which the touch screen of the display 50 was pressed (e.g., a long press), or a size of an area of the touch screen of the display 50 that was pressed).

A touch event may be defined as a detection of an object, such as a stylus, finger, pen, pencil or any other pointing device, coming into contact with a portion of the touch screen display in a manner sufficient to register as a touch (or registering of a detection of an object just above the touch screen display (e.g., hovering of a finger). In this regard, for example, a touch event could be a detection of pressure on the screen of touch screen display 50 above a particular pressure threshold over a given area. In one alternative embodiment, a touch event may be a detection of pressure on the screen of touch screen display 50 above a particular threshold time. Subsequent to each touch event, the touch screen interface 54 (e.g., via the detector 60) may be further configured to recognize and/or determine a corresponding stroke event or input gesture. A stroke event (which may also be referred to as an input gesture) may be defined as a touch event followed immediately by motion of the object initiating the touch event while the object remains in contact with the touch screen display 50. In other words, the stroke event or input gesture may be defined by motion following a touch event thereby forming a continuous, moving touch event defining a moving series of instantaneous touch positions. The stroke event or input gesture may represent a series of unbroken touch events, or in some cases a combination of separate touch events. For purposes of the description above, the term immediately should not necessarily be understood to correspond to a temporal limitation. Rather, the term immediately, while it may generally correspond to relatively short time after the touch event in many instances, instead is indicative of no intervening actions between the touch event and the motion of the object defining the touch positions while such object remains in contact with the touch screen display 50. In this regard, it should be pointed out that no intervening actions cause operation or function of the touch screen. However, in some instances in which a touch event that is held for a threshold period of time triggers a corresponding function, the term immediately may also have a temporal component associated in that the motion of the object causing the touch event must occur before the expiration of the threshold period of time.

In an example embodiment, the detector 60 may be configured to communicate detection information regarding the recognition or detection of a stroke event or input gesture as well as a selection of one or more items of data (e.g., images, text, graphical elements, etc.) to an input analyzer 62. The input analyzer 62 may communicate with a replication module 78. In one embodiment, the input analyzer 62 (along with the detector 60) may be a portion of the touch screen interface 54. In an example embodiment, the touch screen interface 54 may be embodied by a processor, controller of the like. Furthermore, the input analyzer 62 and the detector 60 may each be embodied as any means such as a device or circuitry embodied in hardware, software or a combination of hardware and software that is configured to perform corresponding functions of the input analyzer 62 and the detector 60, respectively.

The input analyzer 62 may be configured to compare an input gesture or stroke event to various profiles of previously received or predefined input gestures and/or stroke events in order to determine whether a particular input gesture or stroke event corresponds to a known or previously received input gesture or stroke event. If a correspondence is determined, the input analyzer may identify the recognized or determined input gesture or stroke event to the replication module 78. In one embodiment, the input analyzer 62 is configured to determine stroke or line orientations (e.g., vertical, horizontal, diagonal, etc.) and various other stroke characteristics such as length, curvature, shape, and/or the like. The determined characteristics may be compared to characteristics of other input gestures either of this user or generic in nature, to determine or identify a particular input gesture or stroke event based on similarity to know input gestures.

In an example embodiment, the processor 52 may be embodied as, include or otherwise control the replication module 78. The replication module 78 (also referred to herein as copy-paste module) may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or structure to perform the corresponding functions of the replication module 78 as described below. Thus, in an example in which software is employed, a device or circuitry (e.g., the processor 52 in one example) executing the software forms the structure associated with such means.

The replication module 78 may communicate with the detector 60 and the input analyzer 62. The replication module 78 may copy one or more items of data (e.g., images, text, videos, etc.) selected by a user in response to receipt of data from the detector 60 indicating that the user moved the selected item(s) of data to an edge of the touch screen display 50 such that at least a portion of the item(s) of data is outside of the viewable area of the touch screen display 50. It should be pointed out that the replication module 78 may copy videos, files, email messages, text messages, multimedia messaging service (MMS) messages, icons, folders, user interface views, documents, images, text or any suitable data, information, content or the like that may be viewed on the touch screen display 50. The replication module 78 may also copy any suitable combinations of data. For example, a user may select an item of text and an image at once and the replication module 78 may copy both the selected text and the selected image. The user may select the item of data by utilizing a finger, stylus, pen, or other pointing device. The selection of the item of data to be copied may be performed by double clicking the item of data, long pressing the item of data or according to any other suitable mechanism of selection. It should be pointed out that a user may simultaneously utilize multiple pointing devices, fingers or the like to simultaneously copy multiple items of data. Additionally, in one embodiment a user may select visible indicia (e.g., a thumbnail, icon, etc.) representative of a copied item(s) of data that is moved to an edge of the touch screen display 50 and in response to the selection, the replication module 78 may open the corresponding copied item(s) of data in a related application. For purposes of illustration and not of limitation, tapping an icon at an edge of the touch screen display 50 may invoke the replication module 78 to open a copied image in a gallery application. In another example embodiment, the replication module 78 may first copy one item of data (e.g., image A) in response to visible indicia depicting the copied item of data being moved to an edge of the touch screen display 50 or an edge of a window shown in the touch screen display 50. And in an instance in which the user of the apparatus 50 subsequently selects another item of data (e.g., content B) and moves this item of data (e.g., content B) above the visible indicia depicting the previously copied item of data (e.g., image A), the replication module 78 may group the items of data (e.g., image A and content B). Grouping the items of data may enable the replication module 78 to group copies of content consisting of the items of data (e.g., image A and content B).

In an example embodiment, in response to at least a portion of an item of data being moved to an area outside of an edge of the touch screen display 50, the replication module 78 is configured to generate visible indicia (e.g., a thumbnail) of the copied item(s) of data that may be shown at the respective edge of the touch screen display 50. The visible indicia may indicate that the item of data moved to the edge of the touch screen display 50 is copied by the replication module 78.

In an example embodiment, the detector 60 may trigger the replication module 78 to copy an item(s) of data moved to an edge of the touch screen display 50 in response to detecting that a quantity or amount of the item(s) of data moved outside of the edge of the touch screen display 50, or an edge of a window(s) within the touch screen display 50, equals or exceeds a predetermined threshold (e.g., 50%). In an alternative embodiment, the detector 60 may trigger the replication module 78 to copy an item(s) of data being moved by a user via a finger of the user, a pointing device or the like in response to determining that the user's finger or the pointing device, moving the item of data, traverses an area outside of the touch screen display 50 or an area outside of a window(s) within the touch screen display 50.

It should be pointed out that that replication module 78 is configured to enable multiple items of data to be copied and available to a user for pasting in an area(s) of the touch screen display 50. In this regard, the replication module 78 may enable display of multiple items of visible indicia (e.g., thumbnails, icons, etc.) to be shown at respective edges of the touch screen display 50, or respective edges of a window(s) of the touch screen display 50, indicating that the user moved respective items of data (e.g., two different images or moved the same image twice) to areas outside of an edge(s) of the touch screen display 50 or window(s) of the touch screen display for copying.

In an example embodiment, the replication module 78 may determine an instance in which a view shown on the touch screen display 50 is changed and may enable visible indicia indicative of the copied data (e.g., a thumbnail(s)) to remain visible at the respective edge(s) of the touch screen display 50, or at the respective edge(s) of a window(s) of the touch screen display 50 even after the view is changed (e.g., a change of a view of an email to a view of a website). The visible indicia may serve as an indicator or reminder to the user that copied data is available for pasting.

The replication module 78 may also paste the copied item(s) of data when the detector 60 determines that the visible indicia (e.g., a thumbnail, icon, etc.) is moved from the respective edge of the touch screen display 50, or the respective edge of a window(s) of the touch screen display 50, and is placed in a respective area within the touch screen display 50. The visible indicia may, but need not, be placed or inserted in an area within the touch screen display 50 in response to a drag and drop operation. The drag and drop operation may be performed in an instance in which the user selects the visible indicia at the edge of the touch screen display 50, or at the edge of the window(s) of the touch screen display 50 and drags or moves the visible indicia to a desired area within the touch screen display 50 and deselects or releases the visible indicia to paste the copied data in the respective area of the touch screen display 50.

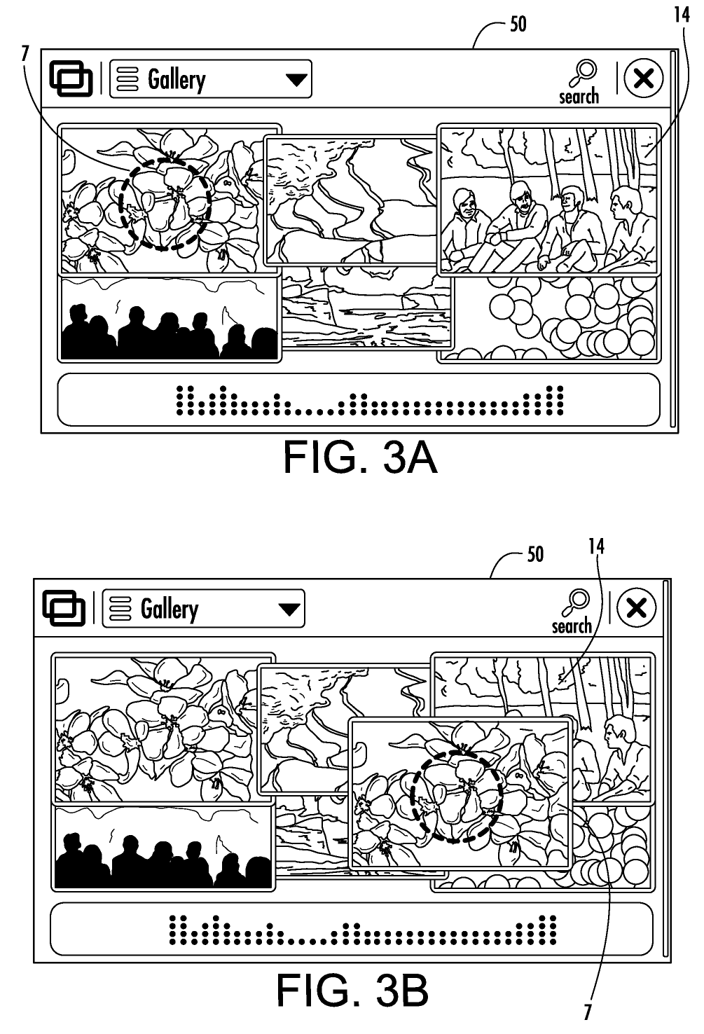

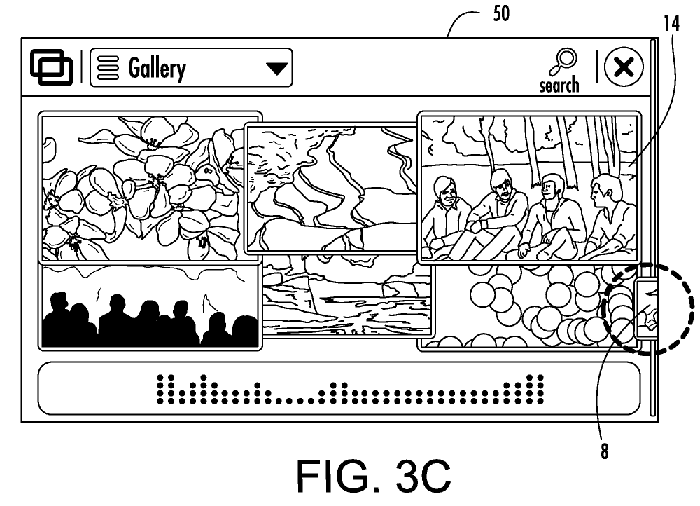

Referring now to FIGS. 3A, 3B and 3C, diagrams illustrating views of a user-friendly touch screen interface and touch screen display that enables reliable copying of data according to an example embodiment are provided. For purposes of illustration and not of limitation FIGS. 3A, 3B, and 3C illustrate copying of one or more items of data, such as, for example, images. However, it should be pointed out that an example embodiment may enable copying of any suitable items of data without departing from the spirit and scope of the invention.

FIG. 3A illustrates that the detector 60 of the touch screen interface 54 detects a selection of an image 7 by a user. The user may utilize a finger, pointing device (e.g., stylus, pen, pencil, mouse, etc.) or the like to select the image 7. It should be pointed out that the detector 60 may detect the selection of the image 7 in response to the user quickly or briefly tapping the image 7. In an alternative embodiment, the detector 60 may detect the selection of the image 7 in response to the user pressing the image 7 for a predetermined time period (also referred to herein as long pressing) (e.g., two seconds, etc.). Additionally or alternatively, the detector 60 may detect that the image 7 is selected in response to the user applying two fingers or two pointing devices or the like to select the image 7. It should be pointed out that selection of the items of data such as for example images may occur in any suitable manner without departing from the spirit and scope of the invention. For instance, in one alternative example embodiment, a detection of a touch input (e.g., selection of an item(s) of data) and a voice input may both be utilized to activate the replication module 78 to copy an item(s) of data. In this regard, the replication module 78 may copy an item(s) of data in response to a user selecting the item(s) of data and then speaking one or more words (e.g., speaking “copy”).

FIG. 3B illustrates that the detector 60 tracks the selected image 7 as it is moved across the touch screen display 50 by the user. The detector 60 may track the selected image 7 as the image 7 is moved across the touch screen display while a finger, pointing device or the like is in contact with a surface of the touch screen display 50. In an alternative embodiment, the user may select the image 7 by utilizing a finger, pointing device or the like to contact a respective surface of the touch screen display 50 and may move the selected image 7 across the touch screen display 50 when the finger or pointing device hovers over the image 7 but is not in physical contact with the surface of the touch screen display 50. In an embodiment in which two fingers or two pointing devices are utilized to select the image 7, the user may utilize the two fingers or two pointing devices to move the image 7 across the touch screen display 50.

FIG. 3C illustrates that the detector 60 may detect that the selected image 7 is moved to an edge of the touch screen display 50. When the detector 60 detects that a portion of the selected image 7 is moved outside of a viewable area of the touch screen display 70, the detector 60 may provide data to the replication module 78 indicating that at least a portion of the selected image is outside of the viewable area of the touch screen display 50, which may trigger the replication module 78 to copy the selected image 7. In this regard, the replication module 78 may copy the selected image 7 and may generate visible indicia 8 (e.g., an icon, a thumbnail) of the selected image. The replication module 78 may copy the selected image 7 in response to receipt of information from the detector 60 that an amount of data of the image 7 that equals or exceeds a predetermined threshold (e.g., 50%), is outside of a viewing area of the touch screen display 50. In an alternative embodiment, the replication module 78 may copy the selected image 7 in response to receipt of information from the detector 60 indicating that the detector 60 determined that a portion of a finger, pointing device or the like, utilized to move the selected image 7, is moved outside of the viewable area of the touch screen display 50.

For purposes of illustration and not of limitation, the visible indicia 8 generated by the replication module 78 may, but need not, be a thumbnail or the like representing a depiction of the copied image 7. As shown in FIG. 3C, the replication module 78 may enable display of the thumbnail at a respective edge of the touch screen display 50 where the user moved the selected image 7. The replication module 78 may save the copied data of the selected image 7 and the data indicative of the thumbnail in memory device 58.

Although FIG. 3C illustrates that the selected image 7 being moved to the right edge of the touch screen display 50 triggers copying of the selected image 7 by the replication module 78, it should be pointed out that moving a selected item of data such as, for example, an image to any edge of the touch screen display 50 may trigger the replication module 78 to copy a selected image regardless of the direction of a particular edge (e.g., right edge, left edge, upper edge, lower edge) of the touch screen display 50.

The replication module 78 may copy more than one item of data on behalf of a user. For instance, with respect to the example embodiments of FIGS. 3A, 3B, and 3C assume that the user also selected image 14. In this regard, the user selects image 14 and moves image 14 to an edge of the touch screen display 50 in a manner analogous to that described above. The replication module 78 may copy the data of the selected image 14 and may generate visible indicia (e.g., an icon, a thumbnail, etc.) indicative of the copied image 14. The replication module 78 may enable display (not shown) of the visible indicia at the respective edge in which the image 14 was moved by the user. In this regard, the replication module 78 may copy multiple items of data such as the selected image 7 and the selected image 14 in this example and may generate visible indicia indicative of the copied images 7 and 14 at respective edges of the touch screen display 50.

Additionally, the replication module 78 may generate another copy of an item of data previously copied in response to a user moving the visible indicia (e.g., visible indicia 8) associated with a selected item of data at a respective edge of the touch screen display 50 in a swift manner. For example, the replication module 78 may generate another copy of the image 7 when the user moves the visible indicia depicting copied content of the image 7 away from the respective edge of the touch screen display 50 such that substantially all of the visible indicia is viewable in a quick manner (e.g., 1 second or less) and then moves the visible indicia back to the respective edge. The additional copy may be generated by the replication module 78 when the user moves the visible indicia back to the respective edge such that a portion of the visible indicia is not shown on the touch screen display 50. In this manner the replication module 78 may generate multiple copies of selected items of data. The replication module 78 may enable display of visible indicia (e.g., a thumbnail, an icon, etc.) corresponding to the additional copies of items of data on the touch screen display 50. The visible indicia corresponding to the additional copies of an item(s) of data may be displayed semi-transparently over visible indicia generated based on a prior copy of the item(s) of data or in any other suitable manner.

It should be pointed out that a user may select multiple items of data at the same time to be copied by the replication module 78. For instance, in the example above, the user may select image 7 with an index finger and may select image 14 with another finger at the same time and move the selected images 7 and 14 across the touch screen display 50 to a respective edge(s) which may trigger the replication module 78 to copy the selected images 7 and 14 at the same time. The images copied at the same time may also be pasted at the same time in a respective area of the touch screen display 50 in a manner analogous to that described below.

In an example embodiment, the detection module 60 may determine an instance in which a user moves an item of data to the same edge of the touch screen display 50 in which another item of data was previously moved. For example, if the detector 60 determines that the user moved selected image 7 and selected image 14 to the same or substantially the same (e.g., within 1 inch of each other) area of an edge of the touch screen display 50, the detector 60 may provide information to the replication module 78 indicating that more than one item of data was moved to the same or substantially the same area of a respective edge of the touch screen display. In response to receipt of this information, the replication module 78 may automatically group the copied images (that the replication module 78 generated) corresponding to selected images 7 and 14 and may store the copied images in the same folder in a memory such as, for example, memory device 58. This may be of benefit to the user when items of data relate to the same kind or category of information or for a number of other reasons. For example, images associated with nature or images taken while on a trip by the user may be grouped together by the replication module 78 when moved to the same edge of the touch screen display 50. When more that one item of data is moved to the same or substantially the same area of a respective edge of the touch screen display 50, the replication module 78 may enable the display of an item of data most recently moved to the respective edge to be displayed semi-transparently over items of data previously moved to the respective edge. However, it should be pointed out that the items of data moved in a same or substantially the same area of a respective edge of the touch screen display 50 may be displayed in any other suitable manner without departing from the spirit and scope of the invention.

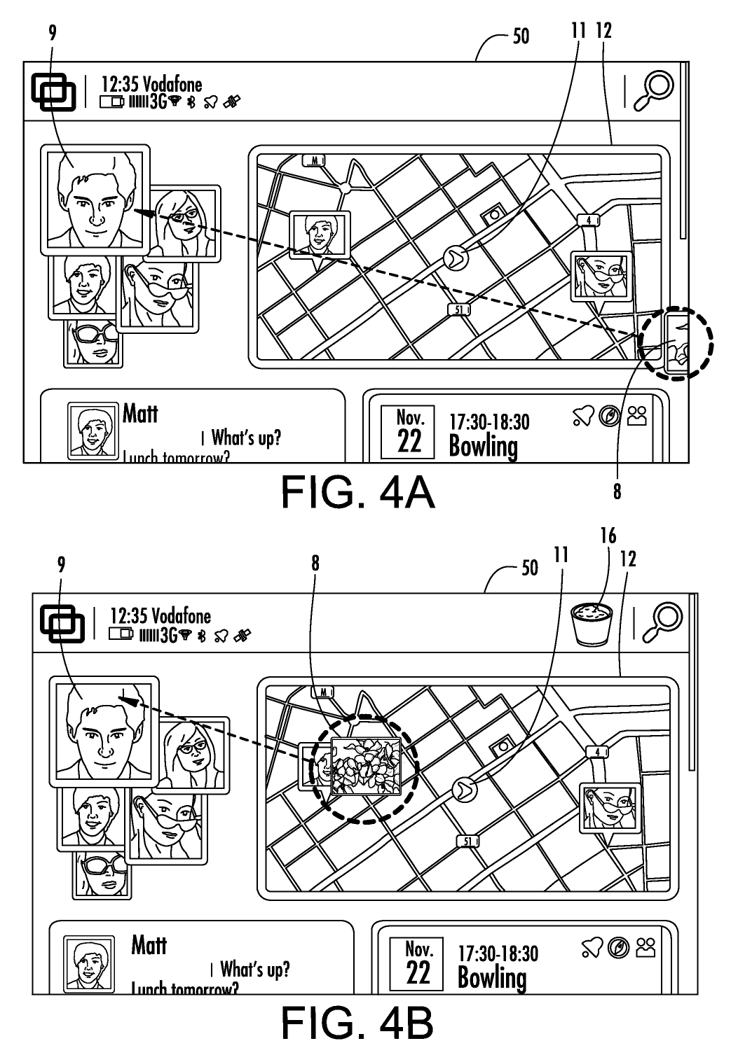

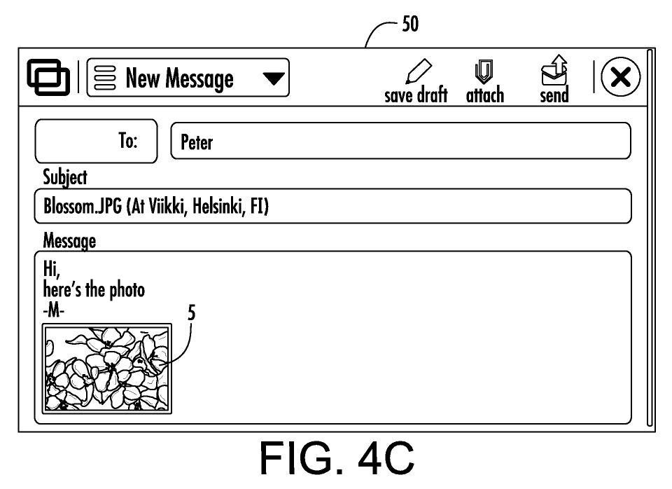

Referring now to FIGS. 4A, 4B and 4C, diagrams illustrating views of a user-friendly touch screen interface and touch screen display that enables reliable pasting of copied data according to an example embodiment are provided. As shown in the example embodiment of FIG. 4A, the visible indicia indicative of the content or item(s) of data copied (e.g., image 7) by the replication module 78 may remain visible (e.g., visible indicia 8) even when a view of the touch screen display 50 is changed. This may be of benefit to the user as it may serve as an indicator or reminder to the user that a copied item(s) of data is available for pasting.

FIG. 4B illustrates that the user may select the visible indicia 8 corresponding to the selected image 7 and move the visible indicia 8 across the touch screen display 50 to a respective area of the touch screen display 50 for pasting of the copied content corresponding to the selected image 7. In this example embodiment, the user may move the visible indicia 8 corresponding to the selected image 7 on top of an image 9 of a person that corresponds to the person's contact card. In response to de-selection of the visible indicia 8 of the selected image 7, the replication module 78 may paste the copied content associated with the image 7 within the touch screen display 50. De-selection of the visible indicia 8 may occur in response to depressing and/or releasing a finger, pointing device or the like that was utilized to select the visible indicia 8.

For example, in the example embodiment of FIG. 4C, de-selection of the visible indicia 8 of the selected image 7 on top of the image 9 corresponding to a person's contact card may enable the replication module 78 to communicate with a messaging application that automatically attaches a copy 5 (also referred to herein as copied content 5) of the image 7 to a message to be sent to a communication address (e.g., email address, short message service (SMS) address, multimedia messaging service (MMS) address, instant messaging (IM) service message, etc.) of a person, such as Peter in this example.

Although FIG. 4C shows that a message is automatically generated including the copied content 5 of the image 7 when the visible indicia 8 is de-selected or released on top of the image 9, it should be pointed out that the copied content 5 may be pasted in any suitable area of the touch screen display 50 without departing from the spirit and scope of the invention. For example, with reference to FIGS. 4A and 4B, the copied content 5 corresponding to image 7 may be pasted on top of a portion 11 of the map 12 when the user moves the visible indicia 8 over the portion 11 and deselects the visible indicia 8 at the respective area corresponding to the area of portion 11. Additionally, it should be pointed out that the copied content 5 of the image 7, for example, may be pasted into any suitable content (e.g., applications, documents, menus, folders, messages, fields, etc.) shown by the touch screen display 50. It should be pointed out that moving substantially all of the visible indicia (e.g., visible indicia 8) depicting the selected item of data (e.g., image 7), as detected by detector 60, into the viewable area of the touch screen display 50 may trigger the replication module 78 to initiate or start a paste operation. Triggering of the paste operation notifies the replication module 78 to paste the corresponding copied content (e.g., copied content 5) in response to receipt of information from the detector 60 indicating a release or de-selection of the visible indicia (e.g., a graphical element such as a thumbnail, an icon, etc.) depicting the copied content of the selected image (e.g., image 7).

Additionally, as shown in FIG. 4B, the touch screen interface 54 may provide the display 50 with a graphical element 16 such as an icon indicating an area in which to move visible indicia (e.g., visible indicia 8) depicting content copied by the replication module 78 that the user no longer desires to paste. In this example embodiment of FIG. 4B, the graphical element 16 may denote an icon representing a trash can or the like. In this regard, the user may move visible indicia to the trash can to delete copied content and remove the corresponding visible indicia from the touch screen display 50.

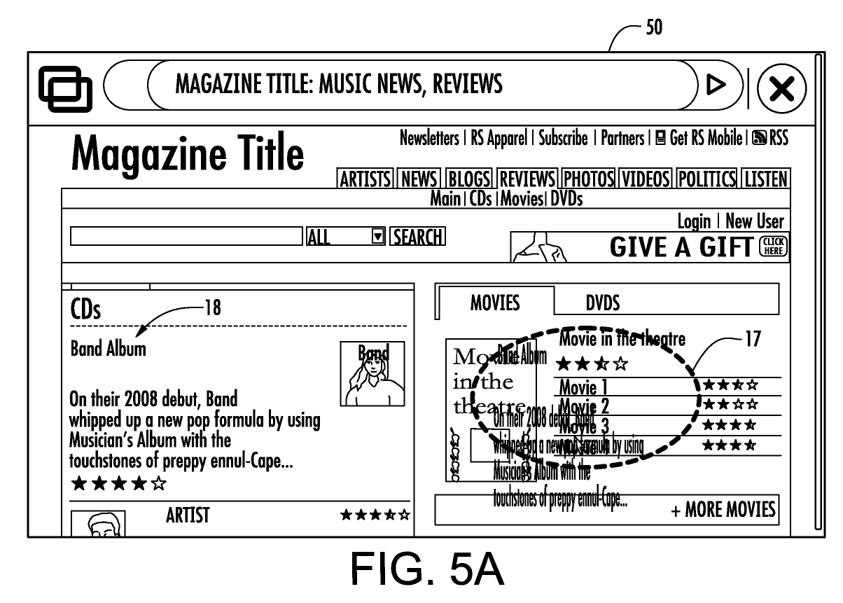

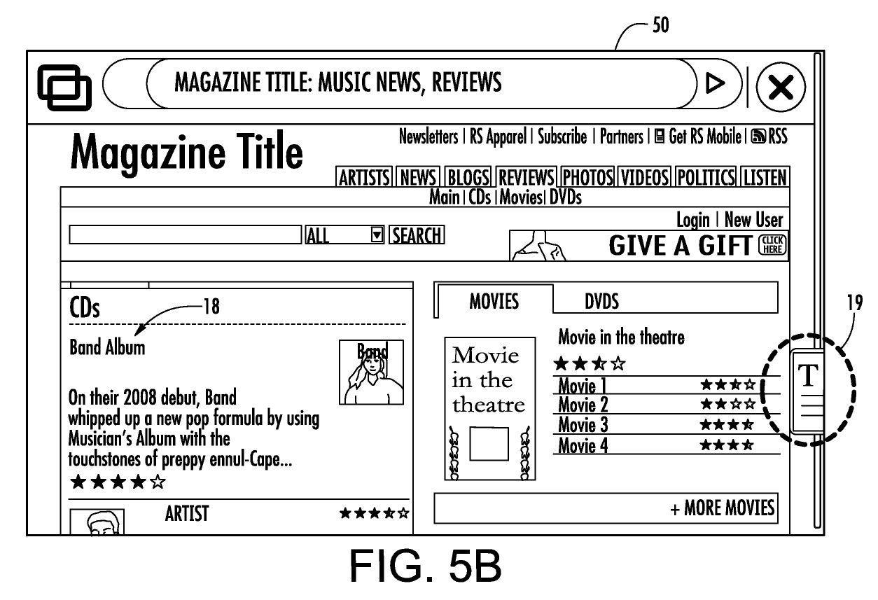

Referring now to FIGS. 5A and 5B, diagrams illustrating views of a user-friendly touch screen interface and touch screen display that enables reliable copying and pasting of data according to an example embodiment are provided. FIG. 5A shows an example embodiment in which a user selects items of data such as for example text 18 from a web page for copying by the replication module 78. In this regard, the user may utilize a finger, pointing device or the like to select text 18 by pressing an upper left corner of text that is desired for selection and moving the finger, pointing device or like across the touch screen display 50 to a bottom right corner such that all of the desired text is selected. It should be pointed out that text may be selected in any other suitable manner. In the example embodiment of FIG. 5A, the text selected may be denoted by the text in the circle 17 (also referred to herein as selected text 17) as it is being moved across the touch screen display 50. The selected text 17 in the example embodiment of FIG. 5A may relate to an album (also referred to herein as Band Album) by a group titled Band.

As shown in FIGS. 5A and 5B, the detector 60 may detect the movement of the selected text 17 as the user utilizes a finger, pointing device or the like to move the selected text 17 across the touch screen display 50 to a respective edge (e.g. right edge) of the touch screen display 50. In response to the detector 60 detecting that the selected text 17 is moved to the respective edge of the touch screen display 50 and that at least a portion of the selected text is outside of the viewable area of the touch screen display 50, the detector 60 may provide the replication module 78 with data indicating that the selected text 17 has been moved to the respective edge. In response to the receipt of the data by the replication module 78, the replication module 78 may copy the selected text 17 in the manner described above with respect to FIGS. 3A, 3B and 3C.

Additionally, the replication module 78 may generate visible indicia 19 corresponding to the copied selected text 17. In the example embodiment of FIGS. 5A and 5B, the visible indicia 19 associated with the copied selected text 17 may be a graphical element such as, for example, an icon, a thumbnail, an image of selected text 17 or the like. In an example embodiment, the visible indicia 19 may, but need not, include data indicating that it relates to selected text. For example, the visible indicia 19 may include a letter “T” denoting that it relates to selected text as well as one or more lines (e.g., three blank lines in FIG. 5B). In an example embodiment, the lines may show at least a portion (e.g., text such as Band Album) of the selected text 17 to indicate to the user the text data that was copied by the replication module 78. Utilizing visible indicia 19 indicating that it relates to selected text may be beneficial and advantageous to the user since the visible indicia 19 may indicate to the user that data is copied and the type of data copied by the replication module 78.

The detector 60 may detect when the user selects the visible indicia 19 and moves the visible indicia 19 to a respective area of the touch screen display 50 for pasting of the corresponding copied content (e.g., selected text 17). In response to the detector 60 determining that the user deselects (e.g., depresses or releases) a selection of the visible indicia 19 that is moved away from a respective edge of the touch screen display 50, the detector 60 may provide the replication module 78 with information that triggers the replication module 78 to paste the copied text associated with the visible indicia 19. In this regard, the replication module 78 may paste a copy of the selected text 17 in a respective area of the touch screen display 50 or within any suitable content shown by the touch screen display 50. For instance, the user may paste the copy of the selected text 17 in a document, message, folder or any other suitable content shown on the touch screen display 50.

In an example embodiment, when the user moves the visible indicia 19 across the touch screen display 50 for pasting the copied text corresponding to selected text 17, the touch screen interface 54 may enable the visible indicia 19 to be displayed as a thumbnail, icon or the like that corresponds to the selected text 17. In this example embodiment, when the user deselects the visible indicia 19, the replication module 78 may enable pasting of the copied text corresponding to the selected text 17 in an area within the touch screen display 50.

In an alternative example embodiment, when the user moves the visible indicia 19 across the touch screen display 50 for pasting the copied text corresponding to selected text 17, the touch screen interface 54 may enable the visible indicia 19 to be displayed as selected text 17. In this alternative example embodiment, when the user deselects the visible indicia 19, the replication module 78 may enable pasting of the copied text corresponding to the selected text 17 in an area within the touch screen display 50 or within content shown on the touch screen display 50.

In another alternative example embodiment, when the replication module 78 generates the visible indicia 19 (e.g., an icon or thumbnail or the like), the replication module 78 may adjust the size of the visible indicia (e.g., icon or thumbnail) based on the amount of text that is selected and copied by the replication module 78. For example, the larger the quantity of text selected by the user and copied by the replication module 78, the larger the size of the visible indicia (e.g., icon or thumbnail) generated by the replication module 78. On the other hand, the smaller the quantity of text selected by the user and copied by the replication module 78, the smaller the visible indicia (e.g., icon or thumbnail) generated by the replication module 78. As an example, if the user selected a few words of text for copying, the visible indicia (e.g., icon or thumbnail) generated by the replication module 78 may be small. However, if the user selected multiple pages of text for copying, the replication module 78 may generate a bigger item of visible indicia (e.g., icon or thumbnail). As such, the size difference between a large item of visible indicia and a small item of visible indicia may signify that different quantities of text were selected by a user and copied by the replication module 78.

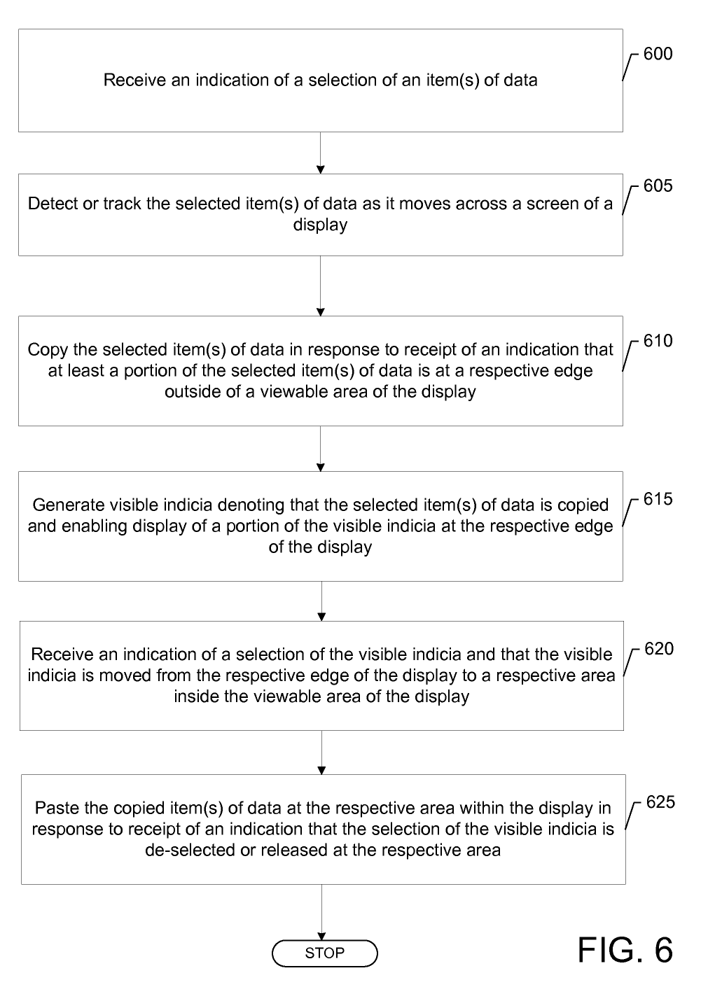

Referring now to FIG. 6, an example embodiment of a flowchart for providing a user-friendly and reliable manner in which to copy and paste data within an input interface in communication with a touch screen display is provided. At operation 600, an apparatus (e.g., apparatus 40) may include means such as the processor 52, the detector 60, replication module 78 and/or the like, for receiving an indication of a selection of an item(s) of data. At operation 605, the apparatus (e.g., apparatus 40) may include means such as the processor 52, the detector 60 and/or the like, for detecting or tracking the selected item(s) of data as it moves across a screen of a display (e.g., touch screen display 50). At operation 610, the apparatus (e.g., apparatus 40) may include means such as the processor 52, the replication module 78 and/or the like, for copying the selected item(s) of data in response to receipt of an indication that at least a portion of the selected item(s) of data is at a respective edge outside of a viewable area of the display (e.g., touch screen display 50).

At operation 615, the apparatus (e.g., apparatus 40) may include means such as the processor 52, the replication module 78 and/or the like, for generating visible indicia denoting that the selected item(s) of data is copied and for enabling display of a portion of the visible indicia at the respective edge of the display (e.g., touch screen display 50). The remaining portions of the visible indicia may be outside of the viewable area of the display. As such, the remaining portions of the visible indicia may not be displayed. The remaining portions of the visible indicia may correspond to portions of the selected item(s) of data that are outside of the viewable area of the display. The visible indicia may, but need not, denote a graphical element such as, for example, an icon or thumbnail as well as an image of a selection of data (e.g., text), etc.

At operation 620, the apparatus (e.g., apparatus 40) may include means such as the processor 52, the replication module 78, the detector 60 and/or the like, for receiving an indication of a selection of the visible indicia and that the visible indicia is moved from the respective edge of the display to a respective area inside the viewable area of the display. At operation 625, the apparatus (e.g., apparatus 40) may include means such as the processor 52, the replication module 78 and/or the like, for pasting the copied item(s) of data at the respective area within the display in response to receipt of an indication that the selection of the visible indicia is released at the respective area. The selection of the visible indicia may be released or de-selected in response to a finger, pointing device or the like depressing a selection of the visible indicia.

It should be pointed out that FIG. 6 is a flowchart of a system, method and computer program product according to an example embodiment of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 58) and executed by a processor (e.g., processor 52, replication module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an example embodiment, an apparatus for performing the method of FIG. 6 above may comprise a processor (e.g., the processor 52, the replication module 78) configured to perform some or each of the operations (600-625) described above. The processor may, for example, be configured to perform the operations (600-625) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600-625) may comprise, for example, the processor 52 (e.g., as means for performing any of the operations described above), the replication module 78, the detector 60 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
generating a copy, via a processor, of at least one selected item of data in response to receipt of an indication that at least a portion of the selected item of data is moved outside of a viewable area of a display or a window of the display at a respective edge of the display or window;
generating visible indicia denoting that the selected item of data is copied;
enabling display of a portion of the visible indicia at the respective edge; and
causing pasting of the copied item of data at a respective area within the display in response to receipt of an indication that a selection of the visible indicia is moved from the respective edge to the respective area and that the selection is released at the respective area.

2. The method of claim 1, wherein generating a copy further comprises determining that a quantity of the portion of the selected item of data moved outside of the viewable area equals or exceeds a predetermined threshold.

3. The method of claim 1, wherein generating a copy further comprises determining that a pointer utilized for selection and movement of the selected item of data across the screen of the display traverses an area outside of the viewable area.

4. The method of claim 1, further comprising:
determining that remaining portions of the visible indicia are outside of the viewable area such that the remaining portions of the visible indicia are not displayed.

5. The method of claim 1, further comprising:
determining that remaining portions of the visible indicia correspond to portions of the selected item of data that are outside of the viewable area.

6. The method of claim 1, further comprising:
determining that the selection is released based on receipt of an indication that the selection of the visible indicia is depressed at the respective area; and
determining that the visible indicia is moved by detecting that the visible indicia is moved entirely within the viewable area of the display or the window.

7. The method of claim 1, further comprising:
generating the visible indicia to comprise a size based at least in part on a quantity of data corresponding to the selected item of data.

8. The method of claim 1, wherein prior to generating the copy, the method further comprises:
tracking the selected item of data as the item of data is being moved across a screen of the display to the respective edge; and
triggering a start of a paste operation in response to receipt of an indication that the visible indicia is moved away from the respective edge entirely within the viewable area.

9. The method of claim 1, further comprising:
generating another copy of the selected item of data in response to receipt of an indication that the visible indicia is moved away from the respective edge and moved back to the respective edge within a predetermined time period.

10. An apparatus comprising:
at least one processor; and
at least one memory including computer program code, the at least one memory and the computer program code configured to, with the at least one processor, cause the apparatus to perform at least the following:
generate a copy of at least one selected item of data in response to receipt of an indication that at least a portion of the selected item of data is moved outside of a viewable area of a display or a window of the display at a respective edge of the display or window;
generate visible indicia denoting that the selected item of data is copied;
enable display of a portion of the visible indicia at the respective edge; and
cause pasting of the copied item of data at a respective area within the display in response to receipt of an indication that a selection of the visible indicia is moved from the respective edge to the respective area and that the selection is released at the respective area.

11. The apparatus of claim 10, wherein the at least one memory and the computer program code are further configured to, with the processor, cause the apparatus to generate the copy by determining that a quantity of the portion of the selected item of data moved outside of the viewable area equals or exceeds a predetermined threshold.

12. The apparatus of claim 10, wherein the at least one memory and the computer program code are further configured to, with the processor, cause the apparatus to generate a copy by determining that a pointer utilized for selection and movement of the selected item of data across the screen of the display traverses an area outside of the viewable area.

13. The apparatus of claim 10, wherein the at least one memory and the computer program code are further configured to, with the processor, cause the apparatus to determine that remaining portions of the visible indicia are outside of the viewable area such that the remaining portions of the visible indicia are not displayed.

14. The apparatus of claim 10, wherein the at least one memory and the computer program code are further configured to, with the processor, cause the apparatus to determine that remaining portions of the visible indicia correspond to portions of the selected item of data that are outside of the viewable area.

15. The apparatus of claim 10, wherein the at least one memory and the computer program code are further configured to, with the processor, cause the apparatus to:
determine that the selection is released based on receipt of an indication that the selection of the visible indicia is depressed at the respective area; and
determine that the visible indicia is moved by detecting that the visible indicia is moved entirely within the viewable area of the display or window.

16. The apparatus of claim 10, wherein the at least one memory and the computer program code are further configured to, with the processor, cause the apparatus to generate the visible indicia to comprise a size based at least in part on a quantity of data corresponding to the selected item of data.

17. The apparatus of claim 10, wherein the at least one memory and the computer program code are further configured to, with the processor, cause the apparatus to:
track the selected item of data as the item of data is being moved across a screen of the display to the respective edge; and
trigger a start of a paste operation in response to receipt of an indication that the visible indicia is moved away from the respective edge entirely within the viewable area.

18. The apparatus of claim 10, wherein the at least one memory and the computer program code are further configured to, with the processor, cause the apparatus to generate another copy of the selected item of data in response to receipt of an indication that the visible indicia is moved away from the respective edge and moved back to the respective edge within a predetermined time period.

19. A computer program product comprising at least one computer-readable storage medium having computer-executable program code instructions stored therein, the computer-executable program code instructions comprising:
program code instructions configured to generate a copy of at least one selected item of data in response to receipt of an indication that at least a portion of the selected item of data is moved outside of a viewable area of a display or a window of the display at a respective edge of the display or window;
program code instructions configured to generate visible indicia denoting that the selected item of data is copied;
program code instructions configured to enable display of a portion of the visible indicia at the respective edge; and
program code instructions configured to cause pasting of the copied item of data at a respective area within the display in response to receipt of an indication that a selection of the visible indicia is moved from the respective edge to the respective area and that the selection is released at the respective area.

20. The computer program product of claim 19, wherein the program code instructions configured to generate a copy further comprise program code instructions configured to determine that a quantity of the portion of the selected item of data moved outside of the viewable area equals or exceeds a predetermined threshold.
